(19) United States
(12) Patent Application Publication
(10) Pub. No.: US 2013/0317730 A1
(43) Pub. Date: Nov. 28, 2013

(54) METHOD FOR IMPROVING THE RELIABILITY OF SPEED LIMIT INFORMATION FOR ON-BOARD SYSTEMS

(71) Applicants: Jean-Marc Van Laethem, Rully (FR); Fabien Pierlot, Boulogne Billancourt (FR)

(72) Inventors: Jean-Marc Van Laethem, Rully (FR); Fabien Pierlot, Boulogne Billancourt (FR)

(73) Assignee: COYOTE SYSTEM SAS, Suresnes (FR)

(21) Appl. No.: 13/822,981

(22) PCT Filed: Jul. 20, 2011
(86) PCT No.: PCT/FR11/00428

§ 371 Date: Aug. 14, 2013

(30) Foreign Application Priority Data
Jul. 20, 2010 (FR) 1003050

(51) Int. Cl. G08G 1/052

(52) U.S. Cl. CPC G08G 1/052
USPC 701/119

(57) ABSTRACT

A method for assessing the quality of the information contained in a database of a remote server storing the speed limit values of various segments of which a road network is composed, in which the speeds in these segments of vehicles having geolocation devices and devices for communicating with the distant server are recorded in a speed database. The server management system takes into account the speed database in order to select the vehicles which, over a predetermined period of time, have travelled at least one predetermined segment; determines the average maximum speed of travel of said vehicles in the segment over the period of time; compares this average maximum speed with the limit value recorded in an authorized speed limit database; assesses the value of the difference between these two values and, if this difference exceeds a given threshold, triggers a monitoring procedure to monitor the segment concerned. Also discloses is an interface device for implementing this method.

### FIELD OF THE INVENTION

The invention relates to a method and a device for enhancing reliability of speed limit indications which are communicated to car drivers, especially indications which are provided by various systems onboard the vehicles.

It is known that, in general, road safety is related to the observation by car drivers of speed limits which are specified on the roads. However, one difficulty is that those speed limits are sometimes distributed in a peculiar way with no apparent connection, from the driver's point of view, between the most critical limitations and the dangerousness of the used road.

Besides, for several years one may have witnessed multiplication of road areas, in which speed limits follow one another and change many times over very short distances, sometimes on few kilometers only, so that the driver must permanently focus on this aspect of the driving, to the detriment of safety.

In addition, the proliferation of speed control devices on highways and on secondary roads, forces the driver to have at all times reliable information on the speed limit of the road section on which he moves.

The driver is helped for that by various drive assisting devices which may be found today onboard many vehicles, and which provide permanently and real time the maximum allowed speed of the road section on which he moves. It is known that most of such devices combine vehicle positioning means such as a satellite geolocation system, or GPS, with speed limits coupled to this positioning which are contained in databases, and then keep the driver informed with appropriate display. Some of those systems are capable, on driver's demand, of signaling any exceeding of the speed limit, e.g. with a sound signal.

One of the major difficulties of those devices is their poor reliability. Indeed, it is known that the databases in which are consigned the speed limits on road sections are hard to update and it is also known that although major road axes are regularly watched, the secondary ones are watched and updated much rarely, so that several months may pass between the variation of a speed limit in situ and hits update in the database cartography.

The present invention aims at alleviating this drawback by proposing a method and a device permitting to update, almost real time, the databases containing speed limits of a road network with excellent reliability, without it being necessary to use service vehicles to make in situ layouts.

The present invention therefore provides a method for assessing quality of information contained in a database of a remote server storing the speed limit values of the various sections forming a road network, including a recording operation, within a database called “speed database”, of speeds in these sections of vehicles having geolocation means and means for communicating with said remote server, wherein the server management means:
take into account said “speed database” in order to select the vehicles which, over a predetermined period of time, have travelled at least one predetermined section;
determine the average maximum speed of travel of said vehicles in said section over said period of time;
compare this average maximum speed with the limit value recorded in an authorized “speed limit database;
assess the value of the difference between these two values and, if this difference exceeds a given threshold, trigger a monitoring procedure to monitor the section concerned.

The threshold may be formed of a given percentage of the limit value recorded.

The present invention also provides a method for controlling the quality of information contained in a database of a remote server storing the speed limit values of the various sections forming a road network, including a recording operation, within a database called “speed database”, of speeds in these sections of vehicles having geolocation means and means for communicating with said remote server, wherein:
the server management means contact the vehicles which move toward a section to be controlled in order to send them a visual and/or sound message;
this message indicates the value of a proposed speed limit for said section, and requests the vehicle user to validate or invalidate this value in function of the real speed limit observed in situ by said user on the section;
once the answer made by the user with manual or sound means for answer capture of communications means of the vehicle, said communication means send to the remote server this validation, invalidation or non-response answer;
the remote server registers this last information and stores it in storage means, such as temporary storage means.

In the invention the server management means may store said answer in temporary storage means and conduct a verification phase. The verification phase may consist in waiting said answer to be by a given number or percentage of identical answers.

The remote server may comprise a database including the references of vehicle users together with indexes of reliability thereof, the verification phase consisting in taking into account the reliability indexes associated with those sole users to confirm said answer.

The reliability indexes associated with users may be contained in a database and are function of answers provided by the users in the past.

The verification phase may be followed by the entry of said answer in the “speed limit database”.

The present invention also provides an interface device to be mounted onboard a vehicle for the processing of a method as previously defined, comprising:
geolocation means;
means for communicating with a remote server;
means for receiving messages from the remote server and means for sending messages thereto.

The receiving means may comprise a display and the sending means may comprise a keyboard including at least two control elements.

The onboard interface device may also be comprised of a smartphone equipped with a GPS.

As a non limiting example, an embodiment of the present invention is disclosed hereinafter, with reference to the appended drawings in which:

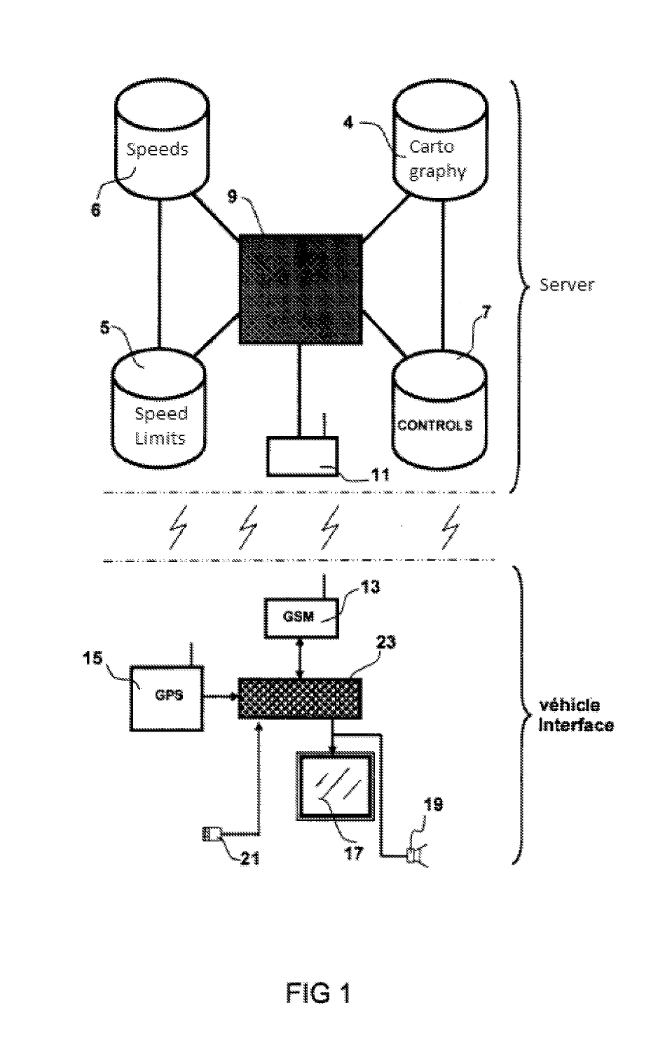

FIG. 1 is a schematic view of a device according to the invention, including a remote server and an onboard interface,

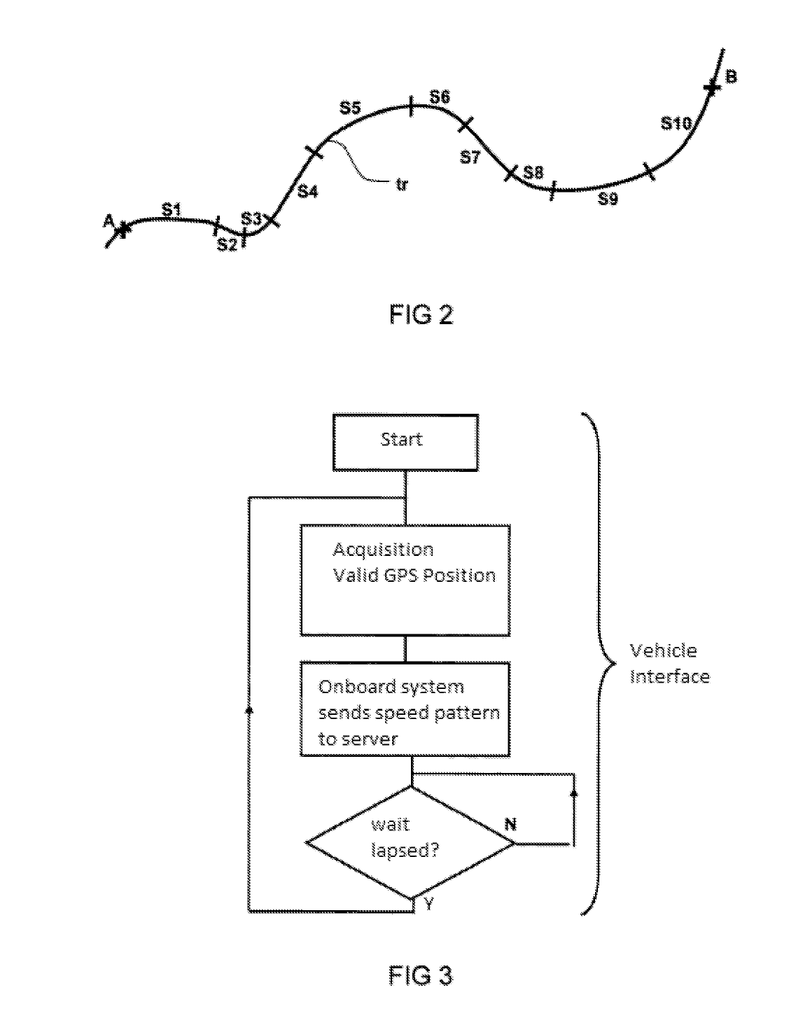

FIG. 2 is a schematic view of a road section and segments which compose this section,

FIG. 3 is a block diagram showing the input of speeds from the vehicles,

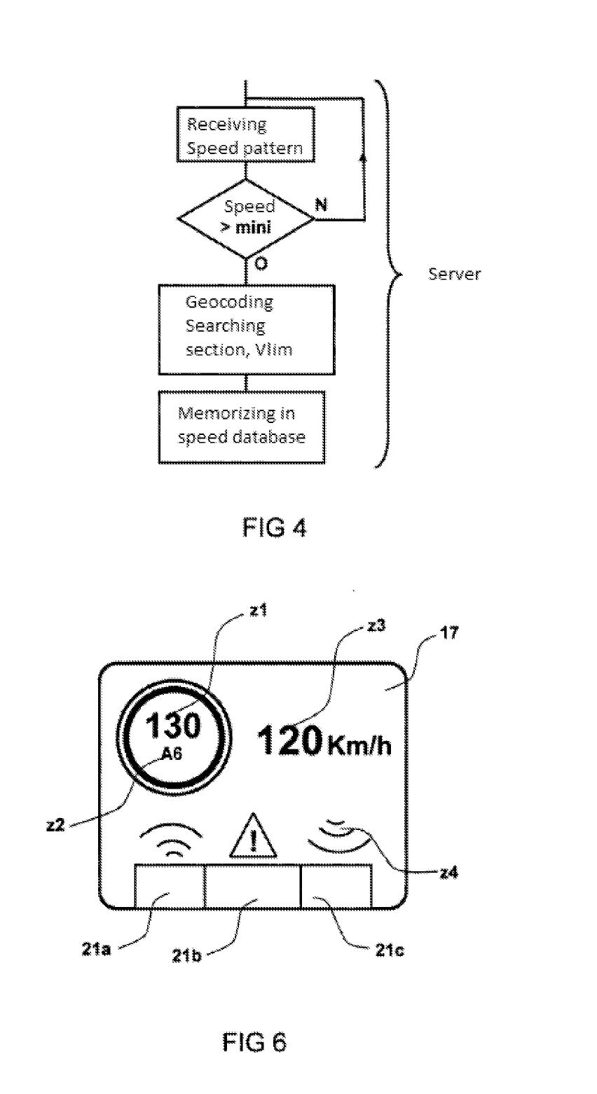

FIG. 4 is a block diagram showing the processing, by the server, of speed information received from the vehicles,

FIG. 5 is a block diagram illustrating the method permitting to detect a possible mistake in the registered speed limit on a road section,

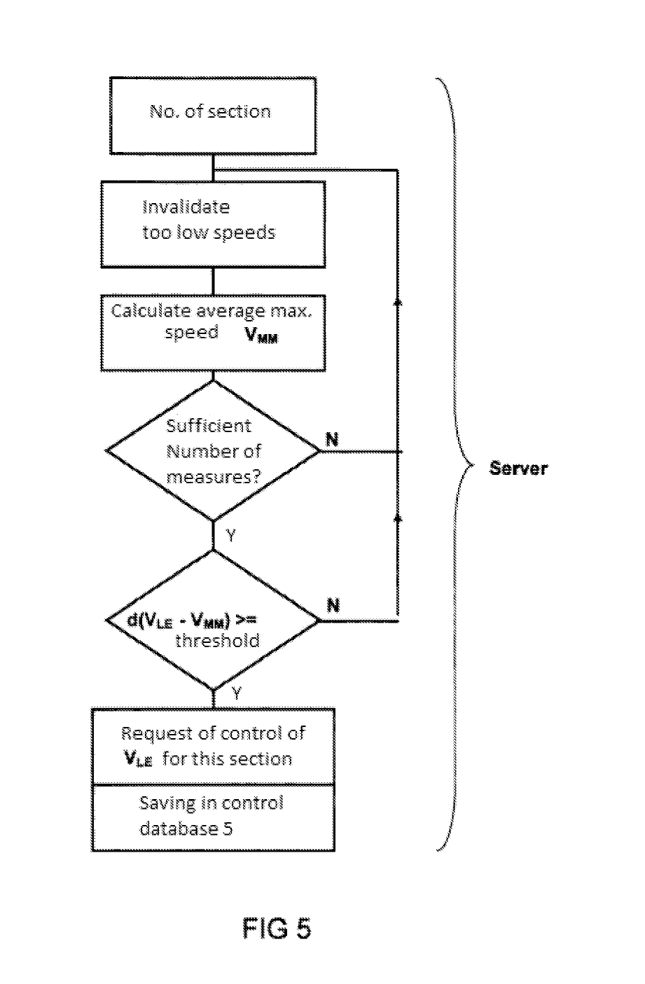

FIG. 6 to 8 show an example of interface onboard a vehicle in three operation sequences of the method of the invention,

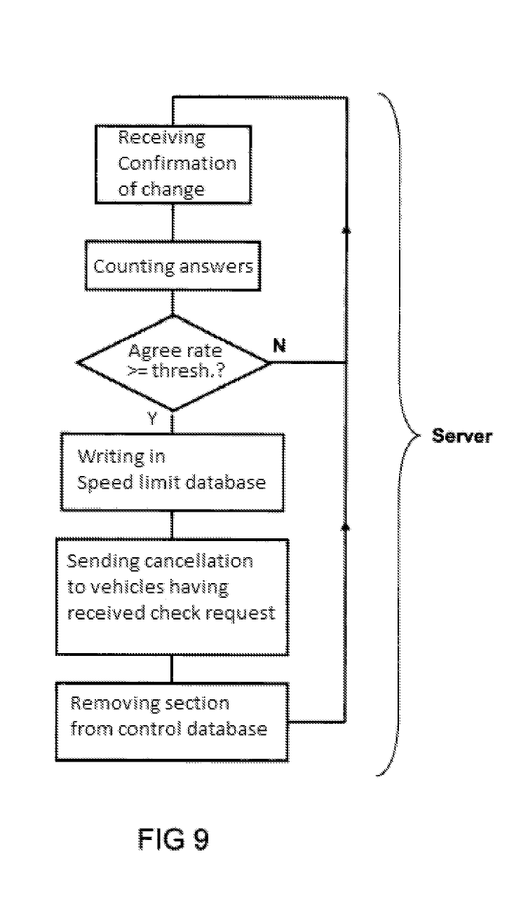

FIG. 9 is a block diagram illustrating the method leading to the amendment of the speed limit database.

As shown on FIG. 1, the system according to the invention essentially relies upon a remote server 1 and vehicles equipped with an onboard interface 3 including geolocation means, e.g. of the GPS type, and means capable to link the latter with the remote server, e.g. via a network of the GPRS or 3G type.

More precisely, in order to achieve this, the different axes of the road network are subdivided in sections each representing an interval in which the speed limit is the same. Each of those sections is recorded by a unique number. The sections are subdivided in a series of segments.

As an example it is represented on FIG. 2 a road section tr which begins at a point A where the speed switches from 90 km/h to 70 km/h and ends in a point B where the speed switches back from 70 km/h to 90 km/h in the case of a vehicle which moves from A to B. This section tr on which the speed is limited a 70 km/h is subdivided in ten segments S₁, S₂, . . . , S₁₀. Those segments include the geometry of the section, in order for the position points which are provided by the geolocation system, e.g. of the GPS type, to be precisely positioned on the closest segment Sₙ.

The remote server 1 comprises several databases, namely a “cartographic database” 4 which includes the cartography of the road network and which permits, in combination with the positioning coordinates provided by the geolocation means, to locate on a map the vehicles equipped with the system, a “speed limit database” 5 which includes section by section all speed limits V_{LE} of the road network, a “speed database” 6 intended for receiving the speeds V measured during the process, and a “control database” 7.

As depicted on FIG. 1, those databases are managed in a known way by a processor 9 to which are connected means of distant communication 11 intended for the communication of the server 1 with vehicles equipped with a specific interface 3.

The latter includes means 13 for distant communication with the server, e.g. of the GSM type, and geolocation means 15, e.g. of the GPS type. It comprises means for displaying visual messages by means of a screen 17 or sound message by means of a loudspeaker 19. It also includes means permitting to send messages to the server 1, e.g. formed of a simplified keyboard 21, the set being controlled by a microprocessor 23.

In these conditions the geolocation system 15 onboard the vehicle periodically sends to the remote server, via the communication means 13, its speed and position coordinates, and the calculation means of the server 1 are capable, by comparison with the data memorized in the “cartography base” 4, of determining on which segment Sₙ of which section tr the vehicle is the closest. Those coordinates of the section together with the speed of the speed of the vehicle are memorized within the “speed database” 6.

The server 1, starting from the “speed limit database” 5, is capable of determining which is the speed limit V_{LE} recorded for the section tr on which the vehicle is and may therefore retransmit to the vehicle, by the distant communication means 11, the recorder speed limit V_{LE} which the vehicle should observe.

In fact, the process permitting to control a database comprises three main steps, namely a first step of inputting speed information, during which the server 1 receives the speed information from the vehicles and classifies them in the “speed database” 6, a second step during which the server 1 detects, section by section, the possibility of mistake in the speed limits V_{LE} recorded in the “speed limit database” and a third step during which the server manages real time the speeds on sections in which it has detected a possibility of a mistake.

During the first step of inputting speed information, as disclosed on the block diagram of FIG. 3, as soon as a valid position of the GPS is inputted, the system onboard each moving vehicle periodically sends to the server a pattern of speed information, namely the date and time together with the latitude and longitude and speed V of the vehicle.

Upon reception by the server 1, as depicted on the block diagram of FIG. 4, if the vehicle speed V is greater than a minimal given value, such as 40 km/h, the server 1 takes into account the elements from the information pattern and the geolocation parameters contained therein, by consulting the “cartography table” 4, reference of the road on which moves the vehicle (e.g. A6), the concerned sections (such as: section tr), the segment (such as: segment S5). Then the management system of the server 1 stores this information together with the speed of the vehicle (e.g. 128 km/h), the speed limit on that section (e.g. 130 km/h), and the date (day and hour) in the “speed database” 6.

During the second step, the server management system conducts operations which aim at detecting the possibilities of errors on the recorded speed limits V_{LE}. As depicted on the block diagram of FIG. 5, the system processes on each section tr of the “speed database” 6 which, for a given period of time, such as one day, has been concerned.

The system aims at assessing the average speed V_{MM} for each section starting from the vehicle speeds V memorized in the “speed database” 6. The system begins with doing a first selection in function of the recorded speed limits V_{LE} of each section and invalidates the speeds V of 30% lower than the speed limit V_{LE} recorded for that section. Then, the system calculates the maximum average speed V_{MM} by calculating the mode, or the most frequent maximum speed watched, for each section and for the given period of time.

The system then checks if, on the concerned section tr, it has a number of measures sufficient to be statistically valid. In other words the system checks whether, on that section, enough vehicles have moved during the given period of time T and have had their parameters recorded within the “speed database” 6.

In that case, the system calculates the difference δV between the speed limit V_{LE} recorded for that section within the “speed limit database” 5 and the maximum average speed V_{MM} of the vehicles which have moved on this section tr during the given period of time T, and this occurs after having eliminated from the calculation the too low speeds, i.e. which are lower than a given minimum value for that section. For example, for a section the recorded speed limit V_{LE} of which is 130 km/h, speeds lower than 100 km/h shall be eliminated.

If the difference δV is equal to or exceeds a given threshold, the system generates a request named “real time control request” for that section, and this request is stored in the “control database” 7 where it will stay until the real time control, which belongs to the third step of the method, is achieved. According to the invention, le speed threshold is either formed by a fixed determined value, or by a percentage X of the speed limit V_{LE} already recorded, this percentage may for example be comprised between 10% and 20%. The following condition will therefore be observed:

δV>=X%·V_{LE}

During the third step, the server management system will check, for the sections for which a real time control request has been recorded in the “control database” 7, if proposals for new speed limits V_{LP} actually correspond to values V_{L0} indicated by signaling panels.

As previously explained, the server management system is capable of knowing if a vehicle is approaching a determined section tr. Thus, according to the invention, as soon as a vehicle is approaching a section for which a real time control request has been recorded, the server sends to this vehicle, via its distant communication means 11 and those 13 onboard the vehicle, an interrogation message.

This message may be of the audio type and/or a message displayed on the screen 17 of the vehicle interface 3.

Interestingly, this screen may gather on a concentrated surface a certain amount of data that, from experience, are essential for the driver's safety. In order to make them even more explicit, certain data may be expressed in different colors, such as on a green base for the data which do not require from the driver a particular attention or, on the contrary, on a red base for the data that the driver should immediately and absolutely take into account.

Depicted on FIG. 6 is an exemplified communication interface 3 onboard a vehicle which gathers in a same sub-assembly the screen 17 and the keyboard 21 including three buttons 21a, 21b, 21c and which is at the driver's disposal to receive the messages from the server 1 and to send others thereto, in response to requests from the server 1 or not.

Thus, in normal operation, the system indicates in the screen zone z1 the recorded speed limit V_{LE} to be observed on the road section tr where the vehicle is located, and in zone z2 located beneath the zone z1 the reference of the road way to which this section belongs. At the right of this information, in zone z3 is to be found the real instant speed V of the vehicle. In this normal navigation configuration, the button 21a allows the driver to signal the remote server the presence of a disturbance in the direction opposite his own driving direction, the button 21c allows the driver to signal the presence of a disturbance in his own driving direction, and the button 21b allows the driver to signal the presence of a peculiar disturbance. The function of those buttons is indicated in a zone z4 of the screen located above the buttons.

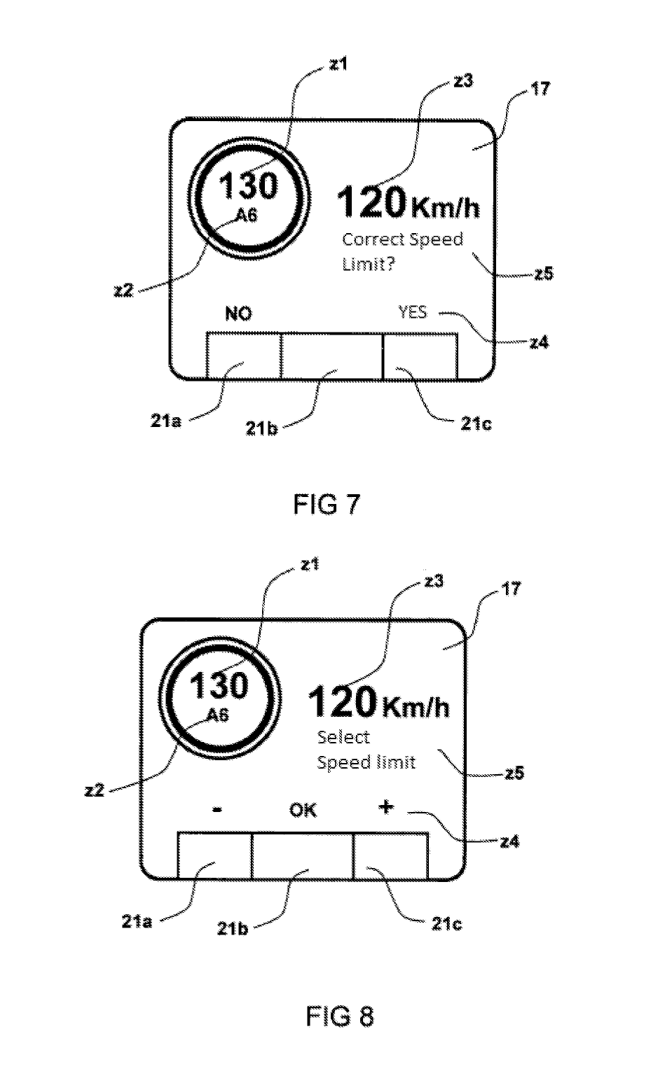

According to the invention, when the server 1 has determined that a vehicle approaches a section tr for which a real time control request was written in the “control database” 7, it checks, preferably in a first step, the reliability of the vehicle driver assuming it has such an information in its database and, in case the driver is reliable, sends the vehicle an interrogation request, such as, as depicted on FIG. 7 “correct speed limit?” displayed in a zone z5 of the screen. In addition, the interface managing system modifies the function allocated to the buttons 21a, 21b, 21c and their new function is displayed in zone z4.

Therefore, a pressure on the right button 21c indicates that the speed limit V_{LO} witnessed by the driver on the signaling panels is actually equal to the recorded speed limit V_{LE} in the zone z1 of his screen, and a pressure on the left button 21a indicates that the witnessed speed limit V_{L0} is different.

In case the driver presses the right button and confirms that the displayed speed limit V_{LE} is correct, the onboard system sends this answer to the remote server which takes it into account as explained hereinafter.

In the contrary case, the onboard interface management software modifies the screen zone z5, as depicted on FIG. 8, in order to display a message requesting the driver to select a speed limit. It also therefore modifies the function allocated to the buttons 21a, 21b, 21c and the display of zone z4 in order to allow the user to answer to the message displayed in zone z5. The meaning allocated to each of those three buttons is thus, for button 21a value “−”, for button 21b value “OK” and for button 21c value “+”. On each pulse on one left or right button the value of the proposed speed limit Vₚₚ displayed in zone z1 is modified by values respectively decremented and incremented of e.g. 10 km/h. When the expected value is obtained, the driver then pulses the button 21 b “OK” to validate his choice.

As depicted on the block diagram of FIG. 9, at reception of the reply, the server counts in a file the responses sent by the various vehicles moving on that same road section tr and checks if an agreement rate has been established.

The agreement rate may for example be a minimum number of identical responses or a percentage of answers provided by the drivers. As soon as the agreement rate is reached, the system updates the “speed limit database” 5 and cancels the request which had previously been sent to vehicles moving on that section on the real time control of the value of speed limit. At last, the system removes from the “control database” 7 the real time control request for the concerned section.

The interface 3 onboard the vehicle may, according to the invention, be formed of an embedded device, such as within the dashboard, be formed of a removable device, or be formed of a specific application available on a Smartphone equipped with GPS positioning means.

1. A method for assessing quality of information contained in a database of a remote server (1) storing the speed limit values (V_{LE}) of the various sections (tr) forming a road network, including a recording 5 operation, within a database called “speed database” (6), of speeds in these sections of vehicles having geolocation means (15) and means (13) for communicating with said remote server (1), wherein the server management means:
take into account said “speed database” (6) in order to select the 10 vehicles which, over a predetermined period (T) of time, have travelled at least one predetermined section;
determine the average maximum speed of travel (V_{MM}) of said vehicles in said section (tr) over said period (T) of time;
compare this average maximum speed (V_{MM}) with the limit value 15 (V_{LE}) recorded in an authorized “speed limit database (5);
assess the value of the difference (δV) between these two values and, if this difference exceeds a given threshold, trigger a monitoring procedure to monitor the section (tr) concerned.

2. The method according to claim 1, wherein said threshold is formed of a given percentage (x%) of the limit value (V_{LE}) recorded.

3. A method for controlling the quality of information contained in a database of a remote server (1) storing the speed limit values (V_{LE}) of the various sections (tr) forming a road network, including a recording operation, within a database called “speed database” (6), of speeds in these sections of vehicles having geolocation means (15) and means (13) for communicating with said remote server (1), wherein:
the server management means contact the vehicles which move toward a section (tr) to be controlled in order to send them a visual and/or sound message;
this message indicates the value of a proposed speed limit (V_{LP}) for said section (tr), and requests the vehicle user to validate or invalidate this value in function of the real speed limit (V_{LO}) observed in situ by said user on the section (tr);
once the answer made by the user with manual or sound means (21) for answer capture of communications means (13) of the vehicle, said communication means (13) send to the remote server (1) this validation, invalidation or non-response answer;
the remote server (1) registers this last information and stores it in storage means, such as temporary storage means.

4. The method according to claim 3, wherein the server management means store said answer in temporary storage means and conduct a verification phase.

5. The method according to claim 4, wherein the verification phase includes waiting said answer to be by a given number or percentage of identical answers.

6. The method according to claim 4, wherein the remote server (1) comprises a database including the references of vehicle users together with indexes of reliability thereof, the verification phase comprises taking into account the reliability indexes associated with those sole users to confirm said answer.

7. The method according to claim 6, wherein said reliability indexes associated with users are contained in a database and are function of answers provided by the users in the past.

8. The method according to claim 5, wherein the verification phase is followed by the entry of said answer in the “speed limit 20 database” (5).

9. An interface device to be mounted onboard a vehicle for the processing of a method according to claim 1, comprising:
geolocation means (15); 25
means (13) for communicating with a remote server (1);
means (13,17) for receiving messages from the remote server (1) and means (13,21) for sending messages thereto.

10. The interface device according to claim 9, wherein the receiving means comprise a display (17) and the sending means comprise a keyboard (21) including at least two control elements (21a, 21b, 21c).

11. The interface device according to claim 9, comprised of a smartphone equipped with a GPS.

12. The interface device according to claim 9, embedded in a vehicle dashboard.
